(19) United States
(12) Patent Application Publication
(10) Pub. No.: US 2008/0074260 A1
(43) Pub. Date: Mar. 27, 2008

(54) SECURITY DEVICE AND METHOD FOR INHIBITING THE UNAUTHORIZED REMOVAL OF A TRANSPORT VEHICLE FROM A DESIGNATED USE AREA

(76) Inventor: Andrew Eric Reiner, Encino, CA (US)

Correspondence Address: Paul M. Schwartz, Esq.;Miller Schwartz, PLC, 6230 Orchard Lake Road, Suite 270, West Bloomfield, MI, 48322, US

(21) Appl. No.: 11/531,925

(22) Filed: Sep. 14, 2006

(51) Int. Cl. G08B 13/14; B60B 33/00; B60R 25/10

(52) U.S. Cl. 340/568.5; 340/426.1; 188/1.12

(57) ABSTRACT

A security device for a transport vehicle for inhibiting the unauthorized removal of the vehicle from a designated use area comprises a mechanism for inhibiting forward movement of the vehicle, a sensor assembly for (a) detecting an attempted removal of the vehicle from the use area and generating a corresponding trigger signal, and (b) detecting a predetermined corrective action and generating a corresponding reset signal, and an actuator in communication with the sensor assembly for receiving the trigger signal and reset signal and activating and deactivating the mechanism respectively.

### CROSS-REFERENCE TO RELATED APPLICATIONS

Not Applicable

### STATEMENT REGARDING FEDERALLY SPONSORED RESEARCH OR DEVELOPMENT

Not Applicable

### TECHNICAL FIELD

This invention relates generally to security devices for transport vehicles, and more particularly, to an anti-theft device and method for preventing the removal of such vehicles, including shopping carts, from retail stores and designated use areas.

### BACKGROUND OF THE INVENTION

Retail stores such as grocery stores, home improvement stores, shopping plazas, gardening centers, supermarkets, big-box retailers, and the like, commonly provide customers with wheeled transport vehicles for holding and transporting purchased merchandise inside and outside of their respective stores. Such vehicles may comprise any suitable apparatus including shopping carts, grocery carts, flat bed carts, wagons, etc. having a wheeled support frame that supports a storage area such as a “basket”. Retail stores may similarly provide (or be required to provide by applicable Federal, State, or Municipal laws or regulations) powered transport vehicles such as medical/mobility electric scooters for holding and transporting physically challenged persons as well as their purchased merchandise. These transport vehicles are relatively expensive to purchase ranging in price from approximately $100.00 for a typical grocery cart to several thousand dollars for an electric scooter. Of course, the larger the store and its daily customer traffic, the greater the number of transport vehicles that are required to be provided and maintained. A big-box retailer or large supermarket may therefore have requirements for several hundred such vehicles at any given time.

Once a customer is finished with a transport vehicle (e.g. the purchased merchandise has been emptied from the basket), the vehicle is typically returned to a designated area such as a coral. Often times, however, the vehicle is simply abandoned in the store's parking lot in proximity to an exit or, more commonly, adjacent a user's car. In the latter case, a store employee must thereafter collect and return the transport vehicle to the coral for use by another customer.

Regrettably, such transport vehicles are often removed without authorization from the grounds and parking lots of retail stores. In urban areas, where users may work or reside within walking distance from the retailer, the vehicle may be “borrowed” for the purpose of assisting the user in carrying purchased merchandise to their destination. Similarly, a transport vehicle may be removed from a retailer premises to assist a user in carrying his or her merchandise to a remote parking location such as on a street or garage. Of course, vehicles may also be removed simply as a prank or for other improper purpose or theft. Regardless of the user's intent, however, the result to the retailer is the same. Many of the removed vehicles are not returned resulting in a permanent loss for the retailer as well as a reduction in available vehicles for customers. Those vehicles that are returned are usually returned at a cost to the retailer. Either way, in anticipation that a certain percentage of such vehicles will be improperly removed, retailers must keep excess vehicles on hand in order to ensure that an adequate number of vehicles are available at all times. In urban areas, vehicles that have been removed are often times abandoned on city streets, in parks and other public areas creating a further nuisance. Adding insult to injury, many municipalities have recently enacted legislation or are in the process of considering or enacting such legislation making retailers responsible for recovering removed vehicles and/or requiring anti-theft devices to inhibit such removal.

Against this background, efforts have been made to prevent wheeled transport vehicles such as shopping carts from being removed or stolen from retail premises and parking lots.

U.S. Pat. No. 2,964,140 to M. N. Berenzy discloses an anti-theft system that employs an electromagnetically actuated, pin-directed braking mechanism which can be installed in place of one or more of the cart's wheels. Once activated, the system moves a horizontally positioned pin into an aperture in the wheel thereby preventing the wheel from further rotation. The Berenzy system incorporates a fixed magnetic field as a means of activating the brake mechanism. More specifically, a magnetic cable is embedded in the concrete or asphalt around the perimeter of a parking lot including across the exit from the parking lot. A sensor activates upon detection of the magnetic field and closes a switch in the control logic of the braking mechanism that, in turn, forces the pin into the aperture.

U.S. Pat. No. 3,717,225 to Rashbaum discloses a pin rod and wheel lock device that includes a frame-mounted actuator that locks one of the wheels of the cart.

U.S. Pat. No. 5,315,290 to Moreno discloses an electronic wheel lock device.

U.S. Pat. No. 4,242,668 to Herzog discloses a collapsible sub frame that causes the wheels to swing out of operative position thereby inhibiting the front wheels of the cart.

U.S. Pat. No. 5,357,182 to Wolfe discloses a braked wheel device.

U.S. Pat. No. 4,524,985 to Drake discloses an arrest device for a wheeled cart that relies on a hooking mechanism in the parking lot.

U.S. Pat. No. 5,576,691 to Coakley discloses a wheel-locking device.

U.S. Pat. No. 4,577,880 to Bianco discloses yet another form of a wheel-locking device.

U.S. Pat. No. 4,722,880 to Goldstein discloses a wheel-locking device that disables only one of the front wheels of the cart.

U.S. Pat. No. 5,194,844 to Zelda discloses a proximity wheel-locking device.

U.S. Pat. No. 4,591,175 to Upton discloses a magnetic wheel-locking device.

The above designs, however, do not eliminate the ability for a user to defeat the respective systems by, for example, lifting the disabled wheels from contact with the ground, leaning the cart to the side on its remaining active wheels, and/or simply tipping the cart on its back wheels and rolling the cart away.

U.S. Pat. Nos. 6,504,923 and 6,271,555 and Published Patent Application No. US2004/0051263 all to Prather disclose various embodiments of anti-theft systems for shopping carts that include a collapsible front suspension assembly and a secondary set of casters fixed to the cart base for preventing the cart from moving in a linear direction when the front suspension assembly collapses and is rendered inoperative. The systems further include one or more active tilt inhibiting devices such as stop dogs to preclude the user from defeating the system. The systems are triggered by an activation signal and once triggered restrict the cart to a circular path until reset by authorized personnel using a mechanical reset key.

U.S. Pat. No. 6,502,669 to Harris discloses a modified swivel caster having a wheel that is mounted to a cart in place of a preexisting swivel caster. The modified caster is moveable between a first position wherein the caster may rotate freely about a vertical axis and a second position wherein such rotation is restricted. The system is triggered by receipt of a discrete infrared signal from a transmitter such as a pencil shaped transmitter positioned at a store exit, a global transmitter, or a buried transmitter. As disclosed, the pencil shaped transmitter and buried transmitter are each hardware programmable for transmitting a signal having a frequency that is programmable by setting the pattern of a DIP switch or the like. The global transmitter is software programmable in conjunction with a remote controller for transmitting signals having different frequencies including a deactivate signal, an activate signal, a lock up signal and an unlock signal. In operation, the system is activated by receiving an activate signal from one of the transmitters. Thereafter, the device is placed in a lock-up state (i.e. the caster is moved to the second position) upon receipt of a lock-up signal or following a predetermined event such as the subsequent distance of travel of the cart. The system similarly includes one or more active wheel inhibiting devices such as stop dogs to preclude the user from defeating the system.

As shown, these designs are intended to render the transport vehicles completely immobile or indefinitely limited to a restricted path of travel once the respective systems are enabled. Although this may be desirable to avert theft, it is clearly not desirable from a customer-relations or store operations standpoint as it leaves the transport vehicle (and the customer) stranded at the point of lock-up, including those customers who innocently or unintentionally breached the boundaries of the retail store or parking area. Moreover, each of the designs requires direct intervention by store personnel to reset the system to return it to a fully mobile and unrestricted travel state once again.

Consequently, what is needed is an improved security device and method of implementing the same for a wheeled transport vehicle such as a shopping cart, grocery cart, flat bed cart, electric scooter, or the like, that overcomes the difficulties of the prior art. Namely, such a device should eliminate the possibility of a user defeating the system without rendering the vehicle immobile or indefinitely limited to a restricted path of travel.

### BRIEF SUMMARY OF THE INVENTION

It is a principal object of the present invention to provide a security device and method for inhibiting the unauthorized removal of a wheeled transport vehicle from a designated use area.

It is a further object of the present invention to provide such a security device and method which functions to prevent unauthorized removal of a transport vehicle without immobilizing the vehicle or indefinitely limiting its travel to a predetermined path.

It is still further an object of the present invention to provide such a security device and method which functions to automatically deactivate theft prevention mode upon detection of a predetermined corrective action by a user.

Still further, it is an object of the present invention to provide such a security device and method which functions to prevent unauthorized removal of a transport vehicle from a designated use area by inhibiting forward movement or motion of the vehicle following an attempted removal until such corrective action has been taken by the user.

In carrying out these and other objects, features and advantages of the present invention, there is provided a security device for a wheeled transport vehicle such as a shopping cart, grocery cart, flat bed cart, wagon, stroller, medical/mobility electric scooter, and the like for inhibiting the unauthorized removal of the vehicle from a designated use area. Such use areas typically comprise one or more parking lots (car parks) or shopping areas of retail stores such as shopping plazas, gardening centers, grocery stores, supermarkets, big-box retailers, etc. However, any suitable use area may be defined including, but not limited to the boundaries of an amusement park, carnival, garden, sports arena, or other public or private gathering place whether indoors or outdoors.

The security device includes any suitable mechanism for (1) inhibiting forward travel of the vehicle upon detection of an attempted removal of the vehicle from the designated use area; and (2) ceasing such inhibiting action upon detection of corrective action (whether by the user, or as disclosed below, by the vehicle itself). Such mechanisms may include, without limitation, various braking devices, secondary, alternate or collapsible caster sets, variable mode swivel caster assemblies and the like. In a preferred embodiment disclosed herein, the mechanism comprises at least one variable mode swivel caster assembly having a wheel and operative in a first deactivated or “free rotation” position about a vertical axis and a second activated or “restricted rotation” position in which vertical rotation of the caster is restricted while allowing free rotation of the wheel. In this embodiment, the caster, when in the first or “deactivated” position is substantially free to rotate about a vertical axis and the direction of travel of the vehicle is unencumbered. In the second or “activated” position, rotation of the caster about the axis is restricted to a predetermined range of motion and, as a result, the direction of travel of the vehicle is correspondingly restricted to a predetermined path. In an alternative embodiment, the described dual mode operation may similarly be achieved through the use of alternate pairs of casters or caster sets. For example, a first set of casters may function in the first deactivated mode wherein the respective wheels are permitted to freely rotate about their vertical axis. A second set of fixed casters may function in the “activated” mode wherein vertical rotation of the casters about a vertical axis is restricted to a predetermined range of motion. In this embodiment, the first and/or second sets of casters may be collapsible such that only one caster set is functional at a given time. For example, upon detection of an attempted removal of the cart from a designated use area, the first caster or caster set (wherein rotation about a vertical axis is unrestricted) will be disabled and the second caster or caster set (wherein rotation about a vertical axis is restricted) will be enabled. Upon detection of sufficient corrective action (either by the user, or the vehicle itself), the second caster or caster set will accordingly be disabled, and the first caster or caster set will be enabled once again to return the vehicle to its unencumbered mode of operation.

The security device further comprises a sensor assembly including one or more sensors provided in communication with an actuator. The sensor assembly functions to (a) detect an attempted removal of the vehicle from the designated use area and generate a corresponding trigger signal; and (b) detect a predetermined corrective action and generate a corresponding reset signal. The trigger and reset signals are received by an actuator that functions to activate and deactivate the mechanism, respectively. In a preferred embodiment, the sensor assembly is operative to detect the position of the vehicle e.g. relative to the designated use area or a corresponding reference point inside or outside the use area. The sensor assembly may similarly detect travel of the vehicle past one or more predetermined reference points. Still further, the sensor assembly may detect a change in direction of the vehicle or distance traveled by the vehicle after the mechanism is “activated”. The determination of change in direction or distance traveled may be accomplished in any suitable manner including, without limitation, sensing and counting wheel rotations as well as through the use of gyroscopes, global positioning system devices, RFID systems, and other conventional position or direction determining devices.

In keeping with the invention, the reference areas and reference points may, of course, be one and the same, and may comprise or be delineated by, for example, pointed or buried electromagnetic field transmitters or cables, global positioning system transmitters/receivers, discrete transmitters/receivers such as infrared transmitters/receivers, RFID receivers/tags, etc.

In further carrying out the above objects, features and advantages of the present invention, there is similarly provided an improved transport vehicle (e.g. a shopping cart, flat bed cart, medical/mobile scooter, etc.). The vehicle comprises a suitable base structure such as, for example, a base frame having a front member and two side members extending therefrom and terminating in first and second back ends, respectively. Again, any suitable mechanism for inhibiting forward movement of the vehicle in response to a detected removal attempt may be employed including various wheel braking devices, variable mode caster assemblies which change the direction of the cart or otherwise restrict forward movement, etc.

In a preferred embodiment, a set of two swivel caster assemblies is used as such mechanism and is mountable to an underside of the side members or base structure. Each swivel caster assembly includes a wheel and is operative in a first deactivated position with uninhibited rotation about a vertical axis and a second activated position wherein rotation about the vertical axis is restricted to a defined range of motion. In the second activated position, travel of the vehicle is restricted to a predetermined arcuate path such as a circular path, while allowing free rotation of the wheel. A sensor assembly detects an attempted removal of the vehicle from a designated use area and predetermined corrective action by a user, including the original user, a subsequent user, store employee, etc. The sensor assembly generates a trigger signal and a reset signal. The signals are received by an actuator that activates and deactivates the swivel caster assemblies, respectively. As indicated above, the sensor assembly may detect travel of the vehicle past predetermined reference points (which may be the same). Alternatively, the sensor assembly may detect the position of the vehicle in proximity to a designated use area or one or more reference points. Still further, the sensor assembly may detect a predetermined change in direction of travel of the vehicle following enablement of the swivel casters. Yet still further, the sensor assembly may detect distance traveled by the vehicle since the mechanism was activated.

### BRIEF DESCRIPTION OF THE SEVERAL VIEWS OF THE DRAWING

FIG. 1 is a perspective diagram of a prior art wheeled transport vehicle;

FIG. 2 is a partially cut-away front side perspective view of a transport vehicle incorporating the forward motion limiting mechanism of the present invention implemented as an exemplary variable mode caster assembly;

FIG. 3 is an exploded parts view of the forward motion limiting mechanism of FIG. 2;

FIG. 4 is a perspective view of a bottom housing cover of the forward motion limiting mechanism of FIGS. 2-3;

FIG. 5 is an interior view of the bottom housing cover of the forward motion limiting mechanism of FIG. 2-3;

FIG. 6 is an exploded view of the system part of the bottom housing cover of the forward motion limiting mechanism of FIGS. 2-3;

FIG. 7 is an exploded view showing detail of the locking assembly, linkage assembly, and motor of the forward motion limiting mechanism of FIGS. 2-3 with the locking assembly in a default of deactivated position;

FIG. 8 is an exploded view showing detail of the locking assembly, linkage assembly, and motor of the forward motion limiting mechanism of FIGS. 2-3 with the locking assembly in an activated position;

FIG. 9 is a plan view of a representative parking area wherein a single magnetic field generating cable is buried or embedded in concrete to define a designated use area.

FIG. 10 is a plan view of a representative parking area wherein a pair of magnetic field generating cables are buried underground or embedded in a road surface such as concrete to define a designated use area;

FIG. 11 is a block diagram of the method steps of the present invention.

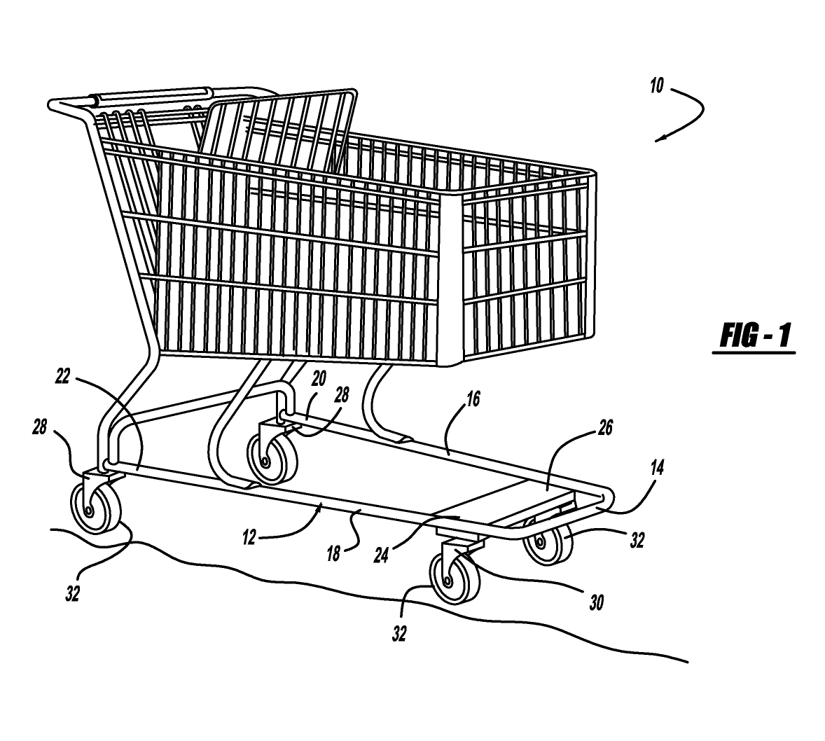

### DETAILED DESCRIPTION OF THE INVENTION

Referring now to the drawings, wherein like reference numerals correspond to like components and functionality, a wheeled transport vehicle is shown and designated generally by reference numeral 10. Transport vehicle 10 is recognized as a conventional shopping or grocery cart typically provided to customers by a retail store such as a shopping plaza, gardening center, grocery store, supermarket, big-box retailer and the like, as discussed above. While transport vehicle 10 is shown for exemplary purposes as a grocery cart, it is understood that the invention described and claimed herein may be incorporated in any suitable wheeled transport vehicle including, without limitation, a flat bed cart, wagon, stroller or powered vehicle such as a medical/mobility stroller, golf cart, etc.

As shown, grocery cart 10 includes a U-shaped base frame 12 comprising a front member 14 and a pair of side members 16 and 18, respectively. Side members 16 and 18 further include respective back ends 20 and 22 and front ends 24 and 26. Casters pairs 28 and 30 are affixable to back ends 20 and 22 and front ends 24 and 26, respectively, and include corresponding wheels 32 which may freely rotate. In the conventional grocery cart shown, rear casters 28 are substantially fixed to back ends 20 and 22 while front casters 30 are of the “swivel” type which permit rotation about a vertical axis therein to allow cart 10 to by steered by a user. Although generally not desirable for most applications, it is understood, however, that rear casters 28 may, of course, also be of the swivel type and front casters 30 may be fixed, or any suitable combination thereof depending on the desired application and use.

As indicated above, various anti-theft devices have been proposed and implemented for transport vehicles that, upon activation, restrict forward movement by either completely immobilizing one or more wheels and thus the vehicle or indefinitely limiting movement of the vehicle to a circular path. In either case, the anti-theft device remains active and the user is left stranded or turning in circles (and thus effectively stranded) until such time as authorized store personnel manually deactivate and reset the device. In the case of large retail stores, where dozens or even hundreds of carts may be in use at any given time, such remedial action may take several minutes to several hours. As readily seen, such a result presents an undesirable and wholly unacceptable inconvenience and annoyance to users and store personnel, especially when users innocently trigger the anti-theft device in the first place. The present invention overcomes the foregoing problem by providing an anti-theft device and transport vehicle that is operative to restrict forward movement of the vehicle upon detection of an attempted removal from a designated use area, but only until such time as the user or the vehicle itself takes appropriate corrective action. Upon detection (or completion) of such predetermined corrective action, the device automatically deactivates and resets itself (without intervention by store personnel) and returns to the normal operating mode wherein full movement and steering of the vehicle is permitted once again.

As indicated above, the invention may be implemented using any suitable forward motion limiting mechanism provided such mechanism is operative to automatically reset itself upon detection of a predetermined corrective action. In a preferred embodiment, such mechanism comprises at least one, and preferably, but not necessarily, a pair of variable mode swivel caster assemblies each operative in at least two modes. In a first default or “deactivated” mode each swivel caster is free to rotate or pivot about a vertical axis normal to the rotational axis of the wheel while allowing free rotation of the corresponding wheels. In a second triggered or “activated” mode, rotation or pivoting of the caster about the vertical axis is restricted while similarly allowing free rotation of the corresponding wheels. More specifically, the casters (and thus the wheels) are oriented (fixedly or biased) at an angle relative to the normal, forward or reverse direction of travel of the transport vehicle. As a result, when the casters are placed in the activated mode, forward motion of the transport vehicle is inhibited and the vehicle is caused to begin to sweep an arcuate path such as a circle. In keeping with the invention, any suitable variable mode swivel caster assembly may be utilized including various mechanical, electromechanical, magnetic and electromagnetic assemblies and combinations thereof, including collapsible assemblies and subassemblies, for achieving the desired variable mode operation.

In an alternative embodiment, such as for use with motor driven transport vehicles (scooters, golf carts, etc.), the above described variable mode operation may similarly be applied to steering assemblies having a first default or “deactivated” mode wherein the assembly operates in its normal uninhibited manner, and a second triggered or “activated” mode wherein any movement of the assembly initiated by the user is limited to a predefined path of travel until detection of appropriate corrective action. Alternatively, the variable mode steering assembly could be programmed along with a suitable vehicle power source to affirmatively power and steer the vehicle to follow a predefined path of travel. In such manner, any attempt by a user to breach the boundaries of a designated use area will trigger the activated mode of the steering assembly and effectively place the vehicle on auto-pilot until the vehicle itself initiates and completes the required corrective action at which time it will return to the normal default mode.

In yet another alternative embodiment discussed above, the described dual mode operation may similarly be achieved through the use of alternate pairs of casters or caster sets. A first caster or caster set may function in the first deactivated mode wherein each wheel is permitted to freely rotate about its vertical axis. A second fixed caster or caster set may function in the “activated” mode wherein vertical rotation of each caster about a vertical axis is restricted to a predetermined range of motion. In this embodiment, the first and/or second caster or caster sets may be collapsible such that only one caster or caster set is functional at a given time. For example, upon detection of an attempted removal of the cart from a designated use area, the first caster or caster set (wherein rotation about a vertical axis is unrestricted) will be disabled and the second caster or caster set (wherein rotation about a vertical axis is restricted) will be enabled. Upon detection of sufficient corrective action (either by the user, or the vehicle itself), the second caster or caster set will accordingly be disabled, and the first caster or caster set will be enabled once again to return the vehicle to its unencumbered mode of operation.

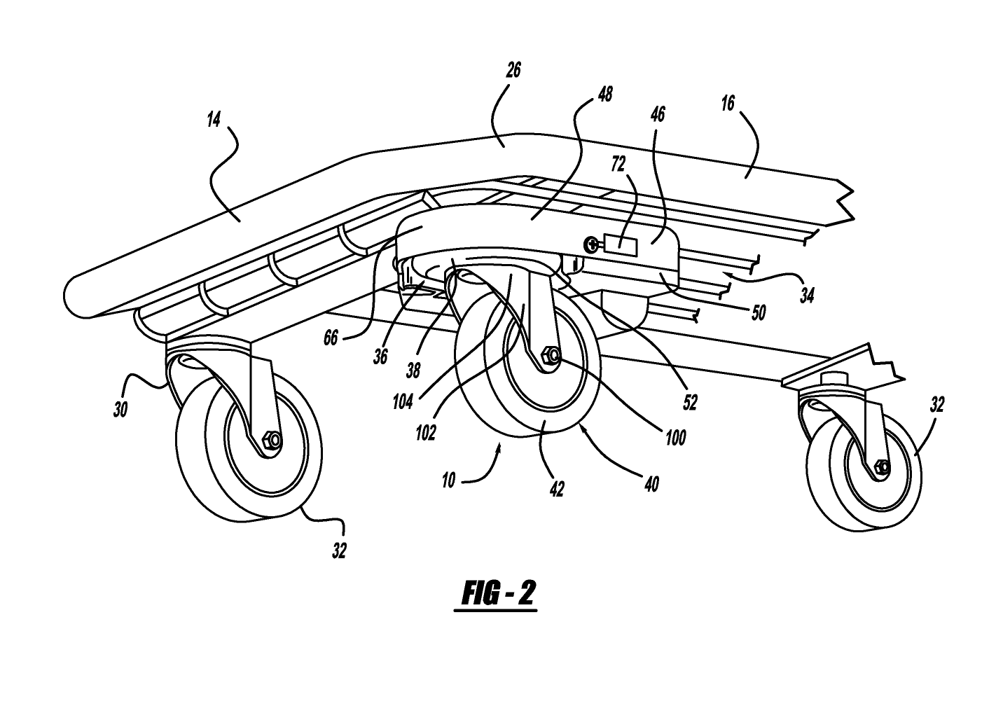

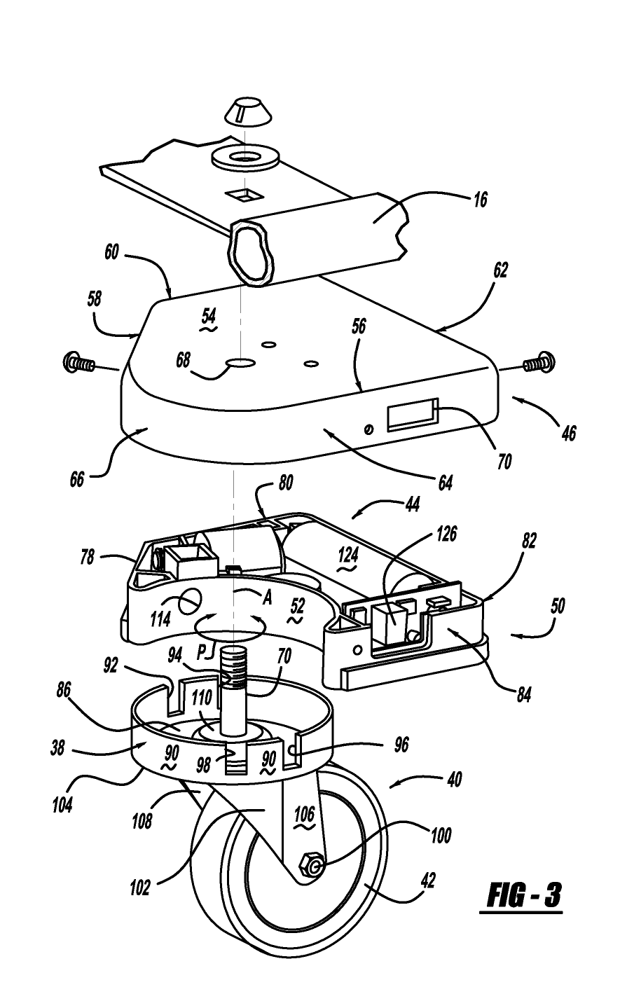

Turning to FIGS. 2-3 of the drawings, one exemplary forward motion limiting mechanism (variable mode swivel caster) of a type anticipated for use with the present invention is shown and referred to generally by reference numeral 34. Mechanism 34 includes a housing 36, a collar member or cup 38, a caster assembly 40 having a wheel 42 and a control system 44. Housing 36 is affixable between base frame 12 and, more particularly base frame front end 26, and the caster assembly 40. The housing 36 may include a top cover 46 having a downwardly extending sidewall 48 and a bottom cover 50 having a cutaway 52 which together define a circumscribing well having an open space vertically extending through the bottom cover 50 of the housing 36 for receiving the collar member 38. In the preferred embodiment shown, sidewall 48 has a rounded or “bullnose” portion and cutaway 52 is substantially crescent-shaped. However, any suitable shapes may be utilized as long as a sufficient well is defined therebetween to permit free rotation of collar member 52 and corresponding caster assembly 40 when the mechanism 36 is in the default or deactivated mode as discussed in further detail below.

Still referring to FIGS. 2-3, control system 44 is disposed within the housing 36 and includes a restricting unit operative to interact with the collar member 38 to preclude vertical rotational motion or swiveling of the caster assembly 40 about a vertical pivot axis while allowing free wheel rotation wherein vehicle travel is restricted to a limited and predetermined arcuate path of travel. More specifically, in the preferred embodiment shown, housing top cover 46 comprises a substantially planar top surface 54 having an outer edge 56 transitioning into and defining a plurality of side wall portions 58, 60, 62, and 64. Sidewall portions 58 and 64 join at a forward point of top cover 46 to form bull-nose shaped sidewall portion 66 and accommodate the shape of bottom cover 50, collar member 38, and caster assembly 40. A stud hole 68 and one or more guide stop holes are formed in the housing top surface 54 to accommodate a mounting stud bolt 70 of the caster assembly 40 and corresponding guide stops. Sidewall portions 58, 60, 62 and 64 similarly have holes formed therein to receive corresponding screws or other suitable fastening means. A cutaway 70 may also be in formed in top cover 46 to receive a window 72 that permits the passage of one or more signals such as infrared signals to control system 44. Alternatively, or in addition thereto, a sensor assembly having one or more sensors may be affixed to caster assembly 40 for detecting an attempted removal of the vehicle 10 from a designated use area and predetermined corrective action by a user, respectively, as will be discussed in further detail below.

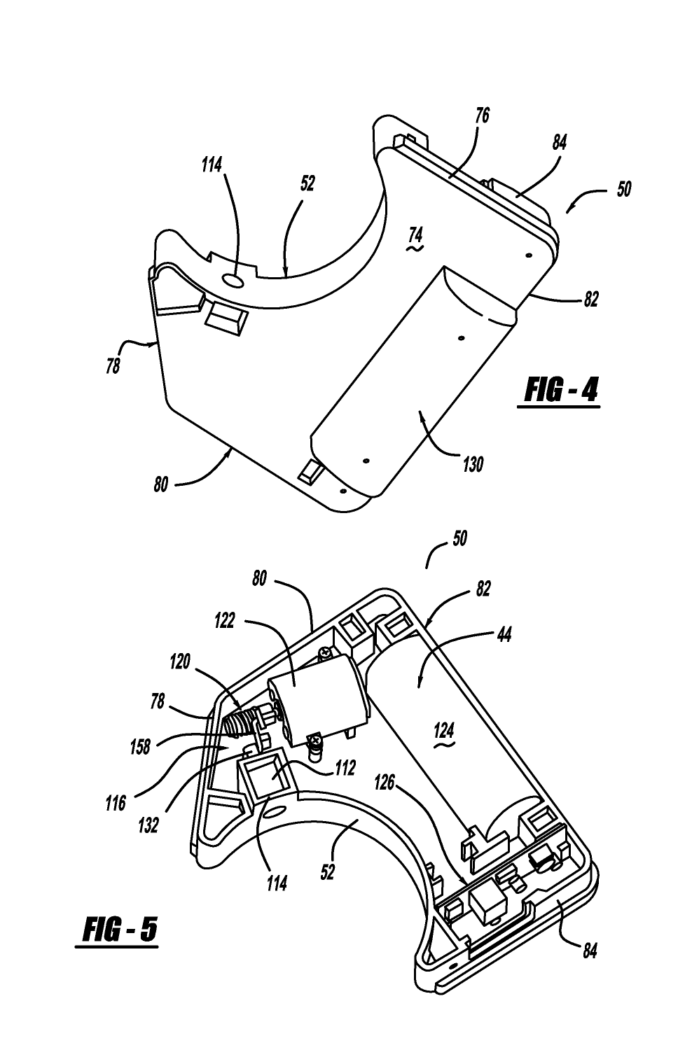

Referring to FIGS. 3 and 4, bottom cover 50, as indicated above, is shaped to fit within top cover 46 and comprises a bottom surface 74. Surface 74 includes an outer edge 76 transitioning into four upwardly extending sidewall portions 78, 80, 82 and 84 that complement top cover sidewall portions 58, 60, 62 and 64, respectively, when assembled. As indicated above, sidewall portions 78 and 84 terminate in crescent-shaped sidewall portion 52 which, when assembled with top cover 46, defines an open substantially circular section for receiving collar member 38 and caster assembly 40. Bottom cover 50 further includes holes disposed in sidewall portions 58, 60, 62 and 64 for receiving suitable fastening members. Collar member 38 may comprise a floor 86 having a hole or other suitable aperture of opening 88 formed in its center to receive caster assembly 40 and mounting stud bolt 70. Collar member 38 is formed by a suitably shaped sidewall, here a circular shaped sidewall 90, transitioning and extending upward from floor 86. Sidewall 90 preferably, but not necessarily, includes a plurality of openings such as notches 92, 94, 96, and 98 that are circumferentially formed within the sidewall at strategic locations to the entry and exit of a locking pin.

Still referring to FIGS. 2-4, caster assembly 40 comprises a wheel 42 having an axle 100 mounted to a forked frame 102 that is pivotally affixable to the mounting stud bolt 70. In operation, the forked frame 102 and wheel 42 can pivot along double ended arrow P and about a vertical axis A, with the axle 100 of the wheel 42 (which defines an axis of rotation of the wheel) offset horizontally from the vertical axis A. More specifically, forked frame 102 comprises a top portion 104 and two spaced apart flanges 106 and 108 that extend downward from top portion 104 to cradle and receive wheel 42 and axle 100. Axle 100 may comprise a suitable fastener such as a button head bolt held in place on the opposite side with a security nut. Top portion 104 of frame 102 comprises a hub 110 that is formed to receive a ball bearing or other suitable bushing through which the stud bolt 70 is inserted and pivotably mounted.

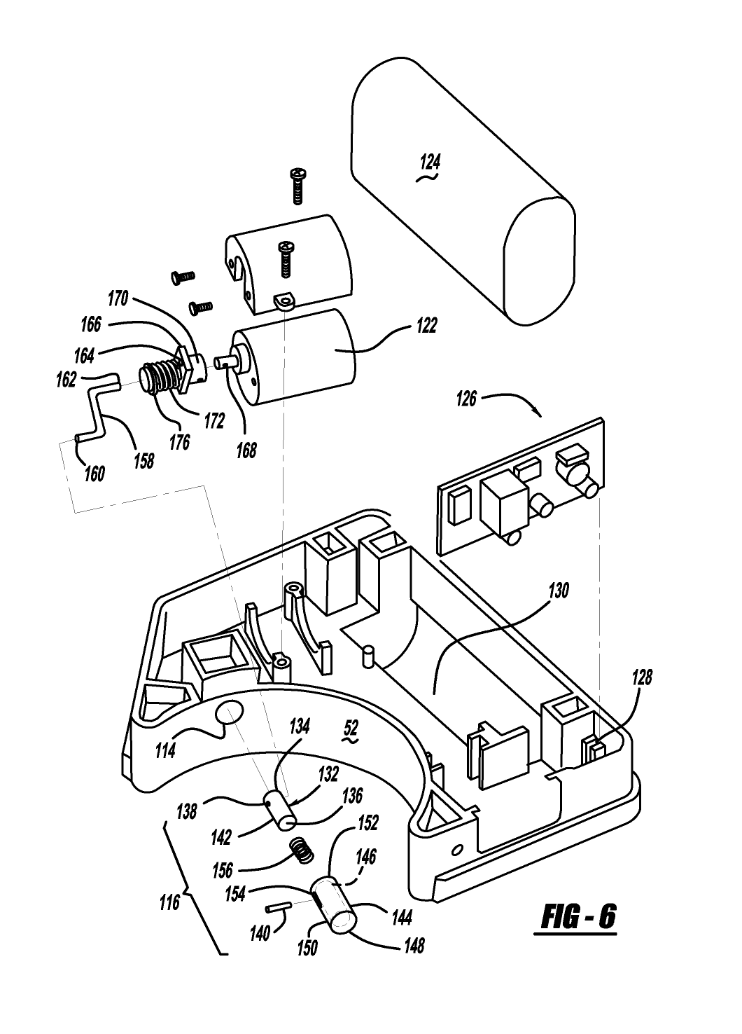

FIGS. 5-6 of the drawings illustrate further details of the bottom housing cover 50 of exemplary caster assembly 40, including a pin housing 112 formed in sidewall portion (crescent wall) 52 having an opening 114 for receiving a locking assembly 116 as discussed in further detail below. Bottom housing cover 50 further includes a control system 44 comprising a locking assembly 116, a linkage assembly 120, a motor 122, a power supply 124, and a processor/controller assembly 126 that may be installed therein. As shown, the processor/controller assembly 126 may be installed in a slot 128 and provided in electrical communication with a power supply 124 such as a battery received in bay 130. Locking assembly 116 comprises a first elongated member/locking pin follower 132 having a first end 134 and a second end 136. Elongated member 132 includes an opening 138 disposed in proximity to its first end 134 and at an angle normal to a longitudinal axis of member 132. Member 132 further includes a pin 140 placed through an opening 142 disposed at a location proximate its second end 136 and at an angle normal to the longitudinal axis of member 132. The locking pin 140 comprises a second elongated member 144 having a hollow blind bore 146 designed to telescopically receive the first member 132 and having a closed forward end 148, a cylindrical sidewall 150 and an open rearward end 152. Second member 144 further includes a pair of elongated openings or slots 154 concentrically disposed through the cylindrical sidewall 150 to receive a spring 156. Spring 156 may be captured between the two members 132 and 144 by placing the spring 156 into the blind bore 146, placing the first elongated member 132 into the blind bore 146 through the open rearward end 132 of second member 146, and compressing spring 156 until the pin opening 142 is aligned with slots 154 such that the pin 140 can be pressed through the opening 142 and can be received within the slots 154. Accordingly, when the first member 132 and the second member 144 are free, the spring 156 pushes the members 132 and 144 apart and biases the pin 144 against the back of the slots 154 proximate the opened end 152 of the second member 144. Further, when the second member or pin 144 is held stationary and the first member 132 is pushed into the second member 144, the spring 156 compresses and potential energy is stored in spring 156.

As shown in FIGS. 5-8, the locking assembly 116 is provided in communication with motor 122 through a linkage assembly 120 comprising a drive link 158 that couples the first member 132 to the motor 122. More specifically, one end 160 of drive link 158 is coupled to the opening 138 disposed in member 132 and its opposite end 162 is disposed in an opening 164 formed in a cam disk spindle 166 disposed on a shaft 168 of the motor 122. Motor 122 includes the shaft 168 wherein there resides a mounting spacer 170, the cam disk spindle 166, and a cam disk spring 172, all of which comprise a subassembly fixedly secured to shaft 168 by a tensioning device such as screw 174. The spacer 170 is affixable to shaft 168 through a pin such as cotter pin 178 pressed through an opening formed in the spacer 170. As shown, an oversized washer 176 is disposed between the tensioning screw 174 and spring 172 to prevent the spring 172 from slipping over the tensioning screw 174.

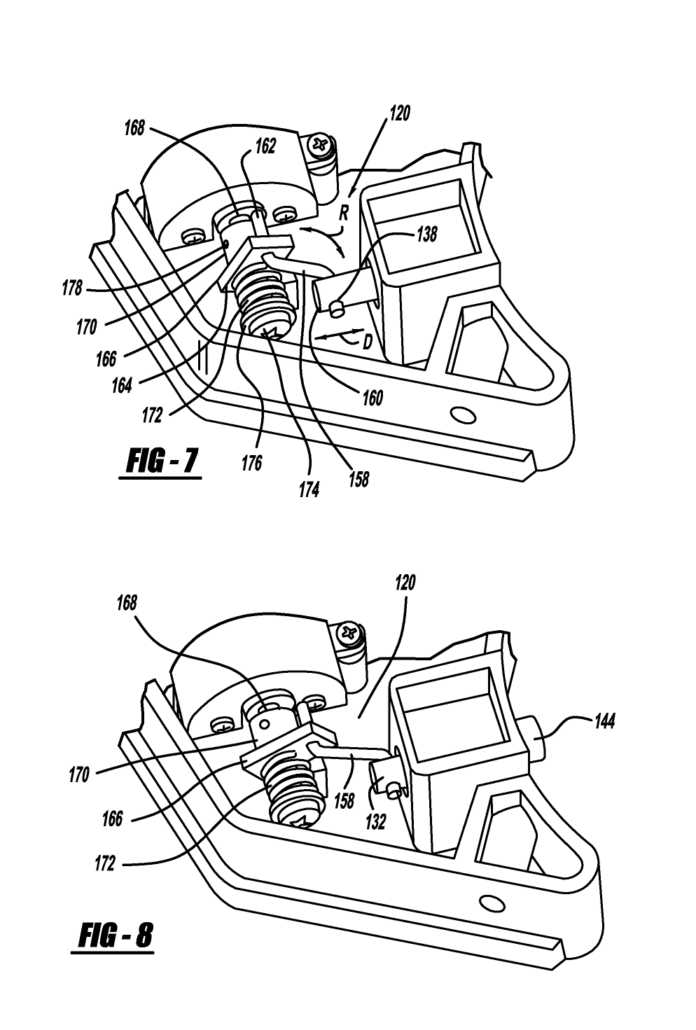

In FIG. 7, mechanism 10 is shown in a default or deactivated state wherein rotational movement of the caster assembly 40 is uninhibited. Accordingly, locking pin assembly 116 has not been actuated. In FIG. 8, mechanism 10 is shown in an activated state. In operation, upon receipt of a trigger signal (corresponding to a detected attempt by a user to remove the vehicle 10 from a designated use area) processor/controller 126 activates motor 122. Shaft 168 thereafter rotates for a fixed period of time to drive the subassembly comprising the spacer 170, spindle 166, and spring 172 such that rotation in one direction of the subassembly about the curved arrow R causes the drive link 152 to turn. As a result, pin member 132, locking spring 156 and locking pin 144 are moved in a forward direction along the path of arrow D to achieve the lock up or “activated” state. Upon receipt of a reset signal (corresponding to detected corrective action by the user), processor/controller 126 activates motor 122 once again. Shaft 168 thereafter rotates for a fixed period of time to drive the subassembly such that rotation in a reverse direction about the curved arrow R causes the drive link 152 to turn. As a result, pin member 132, locking spring 156 and locking pin 144 are moved in a rearward direction along the path of arrow D to return to the default or “deactivated” position.

In keeping with the invention, processor/controller assembly 126 may comprise any suitable device for generating the aforementioned trigger and reset signals upon detection of corresponding user attempts to breach a designated use area and appropriate corrective action, respectively. For example, processor/controller assembly 126 may comprise an infrared receiver operative to receive signals from one or more infrared transmitters affixed in proximity to an exit area, a buried transmitter, etc. Similarly, processor/controller assembly 126 may comprise a magnetic field sensor operative to detect a magnetic field generated by a similarly positioned device or buried cable. Still further, processor/controller assembly 126 may comprise a Radio Frequency Identification (RFID) system such as a passive or active RFID tag or transponder in communication with one or more tag readers, edge servers, middleware and/or application software. Processor/controller assembly 126 may further comprise Global Positioning System (GPS) devices or components operative to determine the exact position of vehicle 10 or position relative to a reference point inside or outside the designated use are. Still further, assembly 26 may comprise one or more devices for detecting a specific change in the direction of travel of the vehicle or a specific distance traveled in the activated mode (and thus an estimated change in direction of travel) for example, by counting wheel rotations. Each of the aforementioned systems (infrared transmitters/receivers, magnetic field sensors/transmitters, RFID tags/transmitters, GPS systems, gyroscopes, wheel rotation counting mechanisms, etc. are well know in the art and, accordingly, need not be discussed in detail.

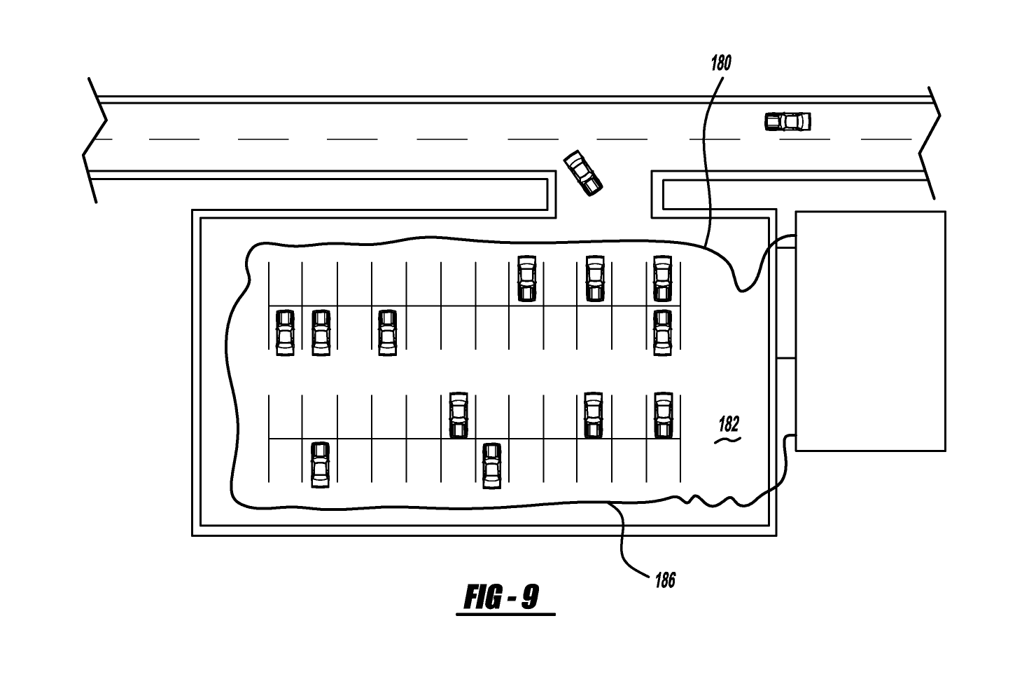

Turning now to FIG. 9 of the drawings, there is shown a plan diagram of an exemplary retail parking area wherein the above-described invention may be implemented on a suitable transport vehicle 10. In the example shown, a single buried cable 180 is provided as the reference point for determining both if a user has attempted to breach the boundaries of a designated use area as well as taken corrective or remedial action. Cable 180 is operative to generate a suitable trigger signal and defines a designated use area 182 within its perimeter. In operation, a transport vehicle 10 equipped with a suitable forward motion limiting mechanism such as a variable mode swivel caster assembly 40, of the type described herein, includes a processor/controller assembly 126 having a signal sensor operative to receive/detect the signal generated by cable 180 when vehicle 10 crosses over or comes within proximity of the cable. Upon receipt/detection of the signal, processor/controller assembly 126 generates a trigger signal to activate motor 122 and thus place the swivel caster assembly in the activated position whereby the caster assembly (and thus the wheels) are oriented at an angle relative to the normal, forward or reverse direction of travel of the transport vehicle. Accordingly, forward motion of the transport vehicle is temporarily inhibited and the vehicle is caused to begin to sweep an arcuate path such as a circle. As the vehicle 10 continues its circular sweeping path, it will eventually change direction and cross over or come within proximity of the cable 180 once again thus defining corrective action by the user. Accordingly, as vehicle 10 crosses or comes within proximity of cable 180, the processor/controller assembly 126, and more particularly, its signal sensor will again receive/detect the signal generated by cable 180 and correspondingly generate a reset signal for receipt by motor 122. Upon receipt of the reset signal, motor 122 will activate once again and return the swivel caster assembly 40 to its default or deactivated position whereby the caster assembly 40 and the corresponding wheels 42 are free to rotate. In such manner, the vehicle 10 is prohibited from full forward movement upon detection of a breach of the designated use area only until such time as corrective action is taken and detected.

As discussed above, many suitable implementations of the invention are anticipated depending on the desired application and use. For example, cable 180 discussed above, may comprise a pair of spaced wires (not shown) that together define both a designated use area (the area enclosed by the wire pair) and a trigger area (e.g. a magnetic field within the space between the wire pair). In this embodiment, passage of the vehicle over or in proximity to the trigger area will similarly trigger the “activated” mode. More specifically, a signal sensor of processor/controller assembly 126 will detect the magnetic field generated by the cable pair when vehicle 10 crosses over or comes within proximity of the trigger area. Upon detection of the signal, processor/controller assembly 126 generates a trigger signal to activate motor 122 and thus places the swivel caster assembly in the activated position whereby the caster assembly (and thus the wheels) are oriented at an angle relative to the normal, forward or reverse direction of travel of the transport vehicle. As the vehicle 10 continues its circular sweeping path, it will eventually change direction and cross over or come within proximity of the trigger area defined by the cable pair thus defining corrective action by the user. The processor/controller assembly 126, and more particularly, its signal sensor will again detect the magnetic field generated by the cable pair and correspondingly generate a reset signal for receipt by motor 122. Upon receipt of the reset signal, motor 122 will activate once again return the swivel caster assembly 40 to its default or deactivated position whereby the caster assembly 40 and the corresponding wheels 42 are free to rotate. In this embodiment, contact between the wire pair effectively cancels the signal. Thus, selected areas such as parking lot walls, store walls, and approved ingress/egress areas etc. may be taken off the grid by simply twisting the wire pairs.

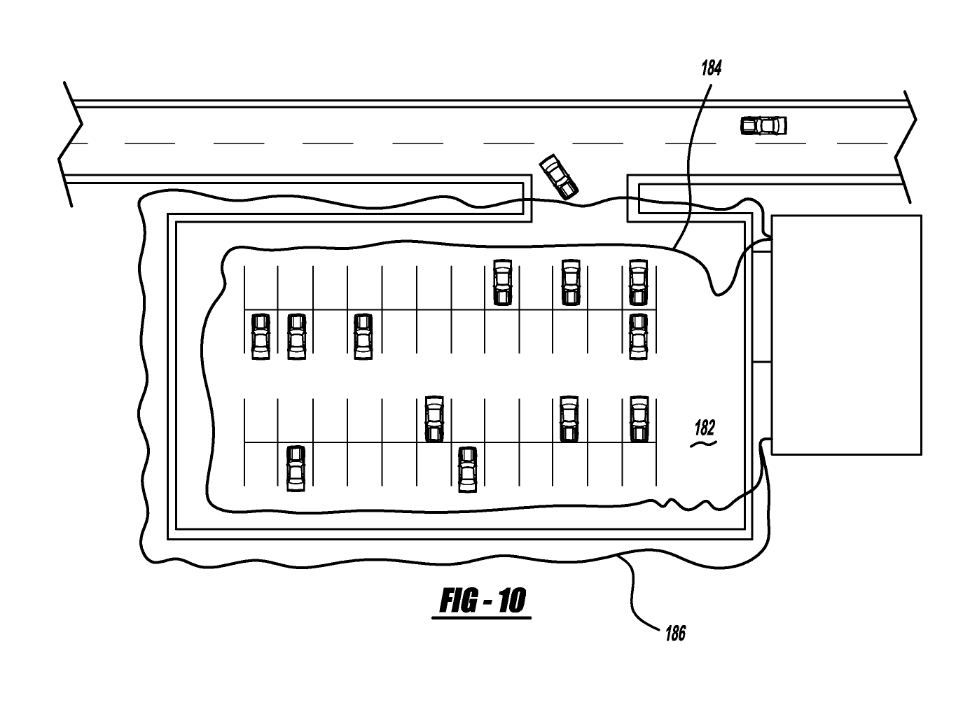

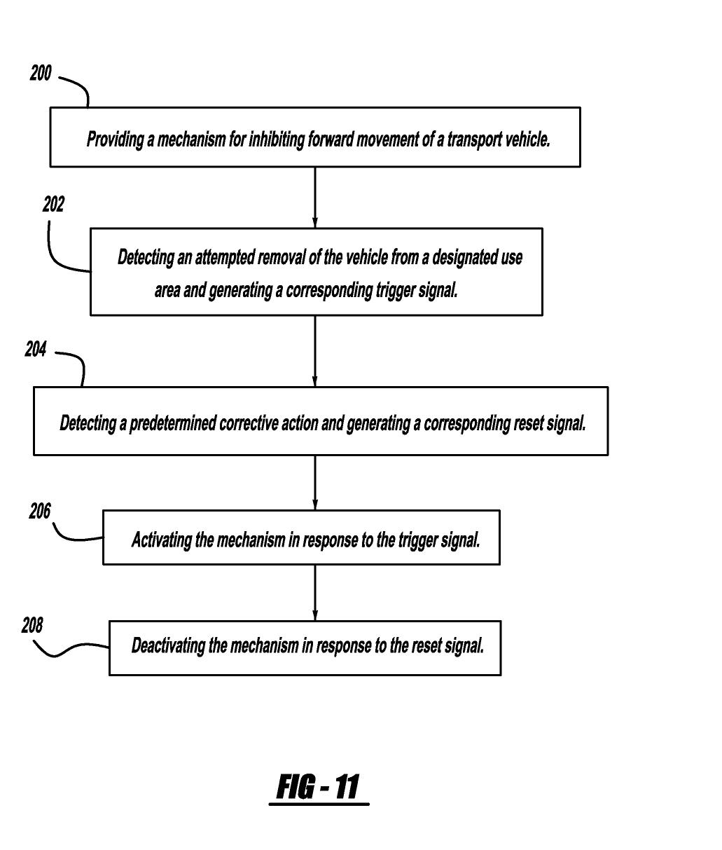

In yet another alternative embodiment, a pair of buried magnetic field generating cables 184 and 186 (inner and outer) or magnets may be utilized to trigger and reset the system, respectively as shown in FIG. 10. In operation, passage of the vehicle over or in proximity to cable 186 triggers the activated mode. Similarly, passage of the vehicle over or in proximity to cable 184 as the vehicle sweeps a circular path and changes directions resets the mechanism 36 and returns the caster assembly 40 to the deactivated mode. The initial passage of vehicle 10 over cable 184 would be uneventful as the forward motion limiting mechanism 36 would already be in the deactivated or default mode.

In yet another embodiment, a buried magnetic field generating cable or other transmitter such as an infrared transmitter may be used as the reference for marking an attempted removal of vehicle 10 from the designated use area 182 and an alternative reference may be used to mark appropriate corrective action by the user including any suitable means for detecting a suitable change in direction of the vehicle or distance traveled (calculated change in direction) since the forward motion limiting mechanism 36 was activated. Such means includes electrical or electromechanical gyroscopes, wheel rotation counting mechanism, timers, GPS receivers/transmitters, etc. A suitable wheel-rotation counting device, for example, may include a counter and a rotation sensor provided in communication with the counter for sensing rotation of the wheel 42 and generating a corresponding output that can be counted by the counter. Such wheel-rotation counting devices are well known in the art and may be software programmed to determine an estimated distance traveled of a vehicle such as cart 10 based on a predetermined count of rotations of wheel 42. Such systems typically further include a suitable memory device for storing a predetermined number of rotations corresponding to a desired distance of travel of the vehicle 10. In operation, the counter compares the counter rotations of wheel 42 to a predetermined number of rotations stored in memory and generates a trigger signal when the counted number meets or exceeds the stored number of rotations.

A determination of the location of a vehicle 10 (in proximity to a boundary of a designated use area or a reference point thereof) may similarly be determined by conventional GPS receivers and transmitters, RFID tags and receivers, etc., again in conjunction with a suitable memory device having desired information stored therein for comparison. Such systems may be software programmed to extremely close tolerances to provide the required information to generate the corresponding trigger and reset signals of the present invention when the determined location falls within designated parameters. Accordingly, various trigger points/reset points may be programmed in memory. For example, a trigger signal may be generated whenever the location of the vehicle 10 is determined to exceed a predetermined distance from one or more reference points inside the designated use area 82 or breaches the defined use area perimeter. Such trigger points may also vary along the use area. For example, a trigger signal may be generated whenever the vehicle exceeds the designated use area 82 by any distance at one point on the perimeter, yet allow several inches or feet to be exceeded at another point before generating a trigger signal. Still further, reset signals may be software programmed to be generated at different points corresponding to different distances traveled or direction changes since the forward motion limiting mechanism was activated, depending on the specific layout of a parking area and where the initial breach occurred. Such systems would be particularly useful for designated use areas with variable boundaries, enclosed areas, multiple exits, etc. wherein multiple different set points would be required to activate and deactivate the forward motion limiting mechanism. Such a system could also be used to implement a third mode wherein full immobilization of the vehicle 10 might be required in situations where any continued movement of the vehicle would result in danger to the user or the vehicle, such as, for example, in proximity to a construction area, highway, pond, or other natural or man-made danger area.

As referenced above, vehicle 10 may also be provisioned to automatically initiate and detect the completion of its own corrective action. Accordingly, upon detection of a trigger signal such as a magnetic field indicative of an attempted removal of the vehicle from a designated use area, a suitable corrective action mechanism (coordinated between a steering assembly and power assembly), will be triggered to affirmatively cause the vehicle to follow a predefined path of travel (or travel to a predetermined location) thus removing control of the vehicle from the user until such time as the vehicle has returned to the designated use area or other predetermined location. For example, with reference to FIG. 9 of the drawings, once the transport vehicle passes over or comes within proximity of cable 180, the corrective action mechanism would be triggered by receipt of a corresponding trigger signal. Once triggered, control (e.g. steering, power, speed, braking, acceleration, etc.) would be removed from the user and the corrective action mechanism would power and steer the vehicle along a predefined path or to a predetermined location within designated use area 182. Once returned to the designated use area 182 (as detected by the vehicle subsequently crossing over or coming in proximity of cable 180), the corrective action mechanism will be turned off and the vehicle will cede control to the user once again and return to the default mode.

With reference to FIG. 11 of the drawings, the method steps of the present invention are shown in further detail and include providing 200 a mechanism for inhibiting forward movement of a transport vehicle. The method further comprises detecting 202 an attempted removal of the vehicle from a designated use area and generating a corresponding trigger signal. Still further, the method includes detecting 204 a predetermined corrective action and generating a corresponding reset signal. Such corrective action may comprise action taken by a user or, alternatively, affirmative action automatically taken by the vehicle (auto-pilot) in response to a detected removal attempt. Finally, the method comprises activating 206 the mechanism and deactivating 208 the mechanism in response to the respective trigger and reset signals.

1. A security device for a transport vehicle for inhibiting the unauthorized removal of the vehicle from a designated use area, comprising:
a mechanism for inhibiting forward movement of the vehicle;
a sensor assembly for (a) detecting an attempted removal of the vehicle from the use area and generating a corresponding trigger signal, and (b) detecting a predetermined corrective action and generating a corresponding reset signal; and
an actuator in communication with the sensor assembly for receiving the trigger signal and reset signal and activating and deactivating the mechanism respectively.

2. A security device as in claim 1, wherein the mechanism comprises a swivel caster having a wheel, the caster operative in a first deactivated position with uninhibited rotation about a vertical axis and a second activated position wherein rotation of the caster about the axis is inhibited such that the direction of travel of the vehicle is restricted to a predetermined arcuate path while allowing free rotation of the wheel.

3. A security device as in claim 1, wherein the sensor assembly is operative to detect travel of the vehicle past a predetermined reference point.

4. A security device as in claim 1, wherein the sensor assembly is operative to detect the location of the vehicle.

5. A security device as in claim 4, wherein the sensor assembly is operative to detect the vehicle outside the designated use area.

6. A security device as in claim 4, wherein the sensor assembly is operative to detect the position of the vehicle in proximity to a reference point within the designated use area.

7. A security device as in claim 4, wherein the sensor assembly is operative to detect the position of the vehicle in proximity to a reference point outside the designated use area.

8. A security device as in claim 1, wherein the sensor assembly is operative to detect a predetermined distance of travel of the vehicle.

9. A security device as in claim 1, wherein the sensor assembly is operative to detect a magnetic field.

10. A security device as in claim 1, wherein the sensor assembly is operative to detect an audio frequency.

11. A security device as in claim 1, wherein the sensor assembly comprises an RFID system.

12. A security device as in claim 1, wherein the sensor assembly is operative to detect a digital signal.

13. A security device as in claim 1, wherein the sensor is operative to detect an infrared signal.

14. A security device as in claim 1, wherein the sensor assembly comprises:
a counter; and
a rotation sensor in communication with the counter for sensing rotation of the wheel and generating a corresponding output which can be counted by the counter;
wherein a predetermined number of rotations of the wheel corresponds to a predetermined change in direction of travel of the vehicle.

15. A transport vehicle, comprising:
a base frame having a front member and two side members extending from the front member and terminating in first and second back ends, respectively;
a mechanism for inhibiting forward movement of the vehicle;
a sensor assembly for (a) detecting an attempted removal of the vehicle from a predetermined use area and generating a corresponding trigger signal, and (b) detecting a predetermined corrective action and generating a corresponding reset signal; and
an actuator in communication with the sensor assembly for receiving the trigger signal and reset signal and activating and deactivating the mechanism, respectively.

16. For use with a transport vehicle, a method for inhibiting the unauthorized removal of the vehicle from a designated use area, comprising:
providing a mechanism for inhibiting forward movement of the vehicle;
detecting an attempted removal of the vehicle from the use area and generating a corresponding trigger signal;
detecting a predetermined corrective action and generating a corresponding reset signal;
activating the mechanism in response to the trigger signal; and
deactivating the mechanism in response to the reset signal.

17. A method as in claim 16, wherein the step of detecting an attempted removal of the vehicle from the use area comprises detecting a position of the vehicle.

18. A method as in claim 17, wherein the step of detecting an attempted removal of the vehicle from the use area comprises detecting travel of the vehicle past a predetermined reference point.

19. A method as in claim 16, wherein the step of detecting a predetermined corrective action by user comprises detecting a predetermined change in the direction of travel of the vehicle.

20. A method as in claim 16, wherein the step of detecting a predetermined corrective action by a user comprises detecting a position of the vehicle.

21. A method as in claim 16, wherein the step of detecting a predetermined corrective action by a user comprises detecting a distance traveled by the vehicle.

22. A method as in claim 16, wherein the step of detecting a predetermined corrective action by a user comprises detecting travel of the vehicle past a predetermined reference point.

23. A method as in claim 16, wherein the step of detecting an attempted removal of the vehicle from a use area comprises detecting a magnetic field.

24. A method as in claim 16, wherein the step of detecting a predetermined corrective action by a user comprises detecting a magnetic field.

25. A method as in claim 16, wherein the step of determining the distance traveled by the vehicle comprises counting rotations of a wheel.

26. A method as in claim 16, wherein the step of detecting an attempted removal of the vehicle from a use area comprises detecting an audio frequency.

27. A transport vehicle, comprising:
a base frame having a front member and two side members extending from the front member and terminating in first and second back ends, respectively;
a set of swivel casters mountable to an underside of the side members, each of the swivel casters having a wheel and operative in a first deactivated position with uninhibited rotation about a corresponding vertical axis and a second activated position wherein rotation of the caster about the axis is inhibited such that the direction of travel of the vehicle is restricted to a predetermined circular path while allowing free rotation of the wheel;
a sensor assembly for (a) detecting an attempted removal of the vehicle from a predetermined use area and generating a corresponding trigger signal, and (b) detecting a predetermined corrective action by a user and generating a corresponding reset signal; and
an actuator in communication with the first and second sensors for receiving the trigger signal and reset signal and activating and deactivating the swivel casters respectively.

28. A security device for a transport vehicle for inhibiting the unauthorized removal of the vehicle from a designated use area, comprising:
a primary mechanism for inhibiting forward movement of the vehicle;
a secondary mechanism for inhibiting all movement of the vehicle a sensor assembly for (a) detecting an attempted removal of the vehicle from the use area and generating a corresponding trigger signal, (b) detecting a predetermined corrective action by a user and generating a corresponding reset signal, and (c) detecting the vehicle in proximity to a danger zone and generating a corresponding brake signal; and
an actuator assembly in communication with the sensor assembly for receiving the trigger signal, reset signal, and brake signal and activating and deactivating the primary mechanism and activating the secondary mechanism.

29. A security device for a transport vehicle for inhibiting the unauthorized removal of the vehicle from a designated use area, comprising:
a mechanism for automatically powering and steering the vehicle in accordance with a predefined path of travel;
a sensor assembly for detecting an attempted removal of the vehicle from the use area and generating a corresponding trigger signal;
an actuator in communication with the sensor assembly for receiving the trigger signal and activating the mechanism.

30. A transport vehicle, comprising:
a corrective action assembly operative to automatically power and steer the vehicle in accordance with a predefined path of travel;
a sensor assembly for detecting an attempted removal of the vehicle from a predetermined use area and generating a corresponding trigger signal; and
an actuator in communication with the sensor assembly for receiving the trigger signal and activating the corrective action assembly.

31. A security device for a transport vehicle for inhibiting the unauthorized removal of the vehicle from a designated use area, comprising:
a mechanism for automatically powering and steering the vehicle in accordance with a predefined path of travel;
a sensor assembly for (a) detecting an attempted removal of the vehicle from the use area and generating a corresponding trigger signal, and (b) detecting completion of the predetermined path of travel and generating a corresponding reset signal;
an actuator in communication with the sensor assembly for (a) receiving the trigger signal and activating the mechanism, and (b) receiving the reset signal and deactivating the mechanism.

32. A transport vehicle, comprising:
a corrective action assembly operative to automatically power and steer the vehicle in accordance with a predefined path of travel;
a sensor assembly for (a) detecting an attempted removal of the vehicle from a predetermined use area and generating a corresponding trigger signal, and (b) detecting completion of the predetermined path of travel and generating a corresponding reset signal; and
an actuator in communication with the sensor assembly for (a) receiving the trigger signal and activating the corrective action assembly, and (b) receiving the reset signal and deactivating the corrective action assembly.

33. For use with a transport vehicle, a method for inhibiting the unauthorized removal of the vehicle from a designated use area, comprising:
providing a mechanism operative to automatically power and steer the vehicle in accordance with a predefined path of travel detecting an attempted removal of the vehicle from the use area and generating a corresponding trigger signal;
detecting completion of the predefined path of travel and generating a corresponding reset signal;
activating the mechanism in response to the trigger signal; and
deactivating the mechanism in response to the reset signal.
